(19) United States
(12) Patent Application Publication
(10) Pub. No.: US 2024/0391403 A1
(43) Pub. Date: Nov. 28, 2024

(54) VEHICLE WIRING STRUCTURE AND VEHICLE

(71) Applicant: Proterial, Ltd., Tokyo (JP)

(72) Inventors: Hirotaka ESHIMA, Tokyo (JP); Yoshikazu HAYAKAWA, Tokyo (JP); Takahiro FUTATSUMORI, Tokyo (JP)

(73) Assignee: Proterial, Ltd., Tokyo (JP)

(21) Appl. No.: 18/663,354

(22) Filed: May 14, 2024

(30) Foreign Application Priority Data
May 23, 2023 (JP) 2023-084793

(51) Int. Cl. B60R 16/03; B60T 13/74; B60T 17/22

(52) U.S. Cl. CPC B60R 16/03; B60T 13/746; B60T 17/22; B60T 2240/00; B60T 2240/03; B60T 2250/00

(57) ABSTRACT

A vehicle wiring structure is provided with a cable having one end located at a wheel side and an other end located at a vehicle body side. The cable connects a wheel-side controller and a wheel speed sensor located at the wheel side to a vehicle body-side controller located at the vehicle body side. The wheel-side controller includes a motor control unit that controls an electric motor that drives an electric brake unit that brakes wheels, and a communication control unit that communicates with the vehicle body-side controller. The communication control unit transmits signals indicating detection results of a motor sensor that detects motor conditions and signals indicating detection results of an on-board sensor to the vehicle body-side controller via a single shared signal line. The cable includes the single shared signal line and a wheel speed sensor-signal line that transmits detection signals of the wheel speed sensor to the vehicle body-side controller.

### CROSS-REFERENCE TO RELATED APPLICATIONS

The present application is based on Japanese patent application No. 2023-084793 filed on May 23, 2023, the entire contents of which are incorporated herein by reference.

### TECHNICAL FIELD

The present invention relates to a wiring structure in a vehicle, i.e., vehicle wiring structure, and a vehicle having the wiring structure.

### BACKGROUND OF THE INVENTION

In recent years, vehicles have become increasingly electronic, and numerous sensors have been placed in various parts of the vehicle. For example, Patent Literature 1 describes the use of sensors to detect tire rotation speed, load, air pressure, and temperature. Patent Literature 2 describes a damper having a displacement sensor that detects the relative displacement of a suspended member and an unsuspended member.

An electric brake that brakes wheels by rotation of a motor has been proposed as an alternative to hydraulic brakes that have been widely used in the past. Patent Literature 3 describes an architecture in which a main electronic control unit located on a body side and a sub electronic control unit located on a wheel side are connected by a composite cable. The main electronic control unit determines the brake force, and the sub electronic control unit supplies three-phase AC current to the motor that operates the electric brake by switching the supply voltage supplied by the main electronic control unit. The composite cable has a pair of power lines and a pair of signal lines. The sub electronic control unit transmits to the main electronic control unit via a pair of signal lines a superimposed signal in which an electric signal related to the control of the motor is superimposed on an electric signal related to the rotation speed of the wheel. This reduces the number of signal lines in the composite cable.
Citation List Patent Literature 1: JP2023-34916A
Patent Literature 2: JP2014-172594A
Patent Literature 3: Japanese Patent No. 7158467

### SUMMARY OF THE INVENTION

Information on the wheel rotation speed is used for integrated control of the vehicle as well as for control of the electric brake. In the architecture of Patent Literature 3, for example, if the sub electronic control unit malfunctions and is unable to communicate with the main electronic control unit, information on wheel rotation speed will not be transmitted to the main electronic control unit, which may cause problems in vehicle control. In the architecture of Patent Literature 3, if a signal indicating tire or damper conditions is superimposed and sent to the main electronic control unit by a pair of signal lines, the frequency of sending a signal indicating detection results of wheel rotation speed to the main electronic control unit will be reduced, which may reduce the controllability of anti-lock control, which suppresses the locking of the wheel, for example.

Therefore, an object of the present invention is to provide a vehicle wiring structure and a vehicle that can appropriately transmit signals indicating detection results of various sensors from the wheel-side controller to the vehicle body-side controller while suppressing the increase in the number of wires in the cable connecting the wheel-side controller located on the wheel side and the vehicle body-side controller located on the vehicle body side.

For solving the above problem, one aspect of the present invention provides a vehicle wiring structure comprising:
a cable having one end located at a wheel side and an other end located at a vehicle body side,
wherein the cable connects a wheel-side controller and a wheel speed sensor located at the wheel side to a vehicle body-side controller located at the vehicle body side,
wherein the wheel-side controller comprises a motor control unit that controls an electric motor that drives an electric brake unit that brakes wheels, and a communication control unit that communicates with the vehicle body-side controller,
wherein the communication control unit transmits signals indicating detection results of a motor sensor that detects motor conditions and signals indicating detection results of an on-board sensor to the vehicle body-side controller via a single shared signal line,
wherein the cable comprises the single shared signal line and a wheel speed sensor-signal line that transmits detection signals of the wheel speed sensor to the vehicle body-side controller.

For solving the above problem, another aspect of the present invention provides a vehicle, comprising:
a wheel-side controller located on a wheel side;
a vehicle body-side controller located on a vehicle body side;
a wheel speed sensor that detects a rotation speed of a wheel;
a cable connecting the wheel-side controller and the wheel speed sensor to the vehicle body-side controller; and
an electric brake unit that brakes the wheel,
wherein the wheel-side controller comprises a motor control unit that controls an electric motor that drives an electric brake unit that brakes wheels, and a communication control unit that communicates with the vehicle body-side controller,
wherein the communication control unit transmits signals indicating detection results of a motor sensor that detects motor conditions and signals indicating detection results of an on-board sensor to the vehicle body-side controller via a single shared signal line,
wherein the cable comprises the single shared signal line and a wheel speed sensor-signal line that transmits detection signals of the wheel speed sensor to the vehicle body-side controller.

### Advantageous Effects of the Invention

According to the vehicle wiring structure and the vehicle of the present invention, it is possible to appropriately transmit signals indicating detection results of various sensors from the wheel-side controller to the vehicle body-side controller while suppressing the increase in the number of wires in the cable connecting the wheel-side controller located on the wheel side and the vehicle body-side controller located on the vehicle body side.

### BRIEF DESCRIPTION OF DRAWINGS

FIG. 1 is a configuration diagram showing an area around a wheel and an electric brake unit in a vehicle according the present invention.

FIG. 2 is an explanatory diagram showing a layout configuration and a wiring structure of a brake controller, a general controller, a wheel speed sensor, a tire sensor, a damper sensor, a wiring harness, and a tire sensor-cable, along with a schematic example of the electric brake unit.

FIG. 3 is a cross-sectional view of a cable taken along the line A-A of FIG. 2.

### DETAILED DESCRIPTION OF THE INVENTION

### Embodiment

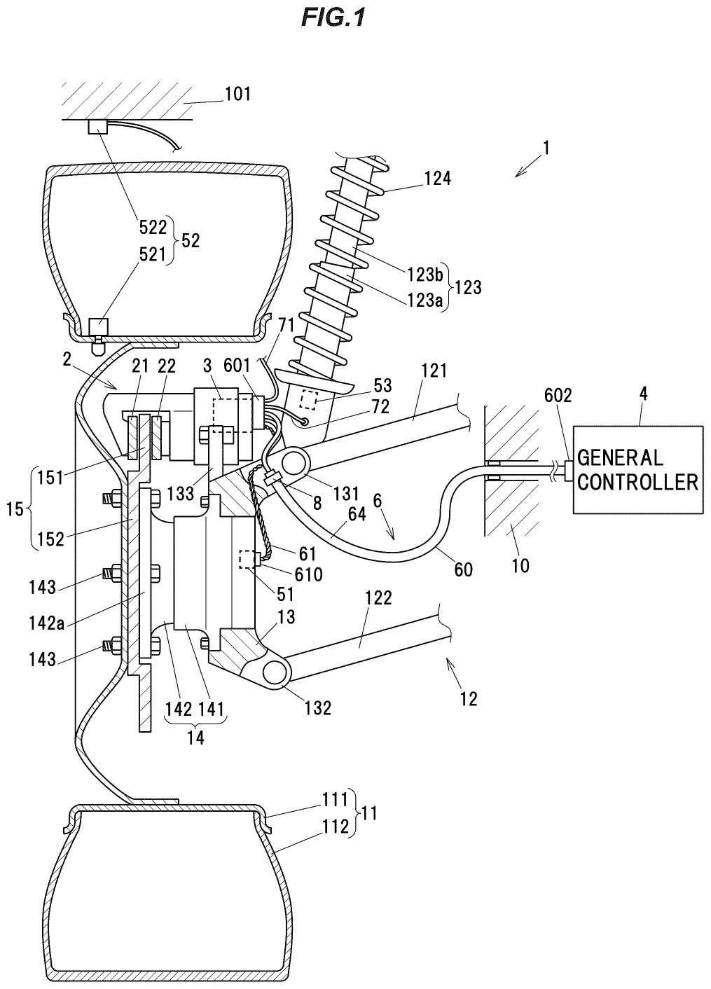

FIG. 1 is a configuration diagram showing the area around a wheel 11 and an electric brake unit 2 in a vehicle 1 of the present invention. The wheel 11 comprises a metal wheel 111 and a tire 112 made of rubber, and is supported by a suspension system 12 relative to a vehicle body 10. The suspension system 12 comprises an upper arm 121, a lower arm 122, a damper 123, and a suspension spring 124. The upper arm 121 and lower arm 122 are each connected at one end to a knuckle 13 and at the other end to the vehicle body 10.

The damper 123 has an outer shell 123a connected to the knuckle 13 and a rod 123b connected to the vehicle body 10 that moves axially in and out of the outer shell 123a. The damper 123 exerts a damping force to inhibit relative movement between the outer shell 123a and the rod 123b. A suspension spring 124 is coaxially disposed around the damper 123 and expands and contracts in response to the vertical movement of vehicle body 10 relative to a road surface.

An outer wheel 141 of a hub unit 14, which rotatably supports the wheel 11, is fixed to the knuckle 13. The knuckle 13 has a first connecting portion 131 to which the upper arm 121 and the outer shell 123a of the damper 123 are connected, a second connecting portion 132 to which the lower arm 122 is connected, and a mount 133 to which the electric brake unit 2 is attached.

The hub unit 14 has the outer wheel 141, and a hub wheel 142 rotatably supported relative to the outer wheel 141. Between an inner surface of the outer wheel 141 and an outer surface of the hub wheel 142, multiple rolling elements, not shown, are disposed in a retainer. The hub wheel 142 has a wheel-mounting flange 142a, to which the metal wheel 111 is attached by multiple hub bolts 143 together with a brake rotor 15. The brake rotor 15 has a friction portion 151 that frictionally slides with brake pads 21, 22 of the electric brake unit 2 and a fixed portion 152 that is fixed to a wheel-mounting flange 142a of the hub wheel 142.

The vehicle 1 has a brake controller 3 that controls the electric brake unit 2, a general controller (supervisory controller) 4 that integrally controls the vehicle 1, a wheel speed sensor 51 that detects the rotational speed of the wheels 11, a tire sensor 52 that detects the condition of the tires 112, a damper sensor 53 that detects the condition of the damper 123, a wire harness 6 including a cable 60, a tire sensor-cable 71 connecting the tire sensor 52 and the brake controller 3, and a damper sensor-cable 72 connecting the damper sensor 53 and the brake controller 3. The brake controller 3 and the wheel speed sensor 51 are connected to the general controller 4 by a wiring structure with the cable 60.

The wheel speed sensor 51 is mounted on the outer wheel 141 of the hub unit 14 and detects the rotational speed of the hub wheel 142 relative to the outer wheel 141. Specifically, the wheel speed sensor 51 outputs a pulse signal with a pulse interval corresponding to the rotation speed of the hub wheel 142 relative to the outer wheel 141 to the general controller 4 as a detection signal. The cable 60 has a wheel speed sensor-signal line 61 that transmits detection signals of the wheel speed sensor 51 to the general controller 4. At the end of the wheel speed sensor-signal line 61, a wheel speed sensor-connector 610 is attached for connection with the wheel speed sensor 51. The configurations of the wiring harness 6 and cable 60 is described below.

The tire sensor 52 is a pneumatic sensor that detects the air pressure of the tire 112. The tire sensor 52 comprises a detection element 521 that transmits a radio wave signal in accordance with the air pressure of the tire 112, and an antenna element 522 that receives the radio wave signal transmitted from the detection element 521. The detection element 521 is mounted on the metal wheel 111. The antenna element 522 is fixed to a non-rotating member that does not rotate with the rotation of the wheel 11. In the present embodiment, the antenna element 522 is attached to a tire house 101 of the vehicle body 10. The tire sensor-cable 71 connects the antenna element 522 to the brake controller 3.

The antenna element 522 may be built into the brake controller 3. In this case, the tire sensor-cable 71 is not needed. A temperature sensor to detect the temperature of the tire 112 and a load sensor to detect the load on the tire 112 may be placed inside or around the tire 112 as tire sensors.

The damper sensor 53 is mounted on the outer shell 123a and detects the position of the rod 123b relative to the outer shell 123a. The damper 123 may be a variable damping-force damper that can adjust the pressure in the cylinder in the outer shell 123a where the rod 123b enters and exits. In this case, a pressure sensor capable of detecting the pressure in the cylinder may be provided as a damper sensor to detect conditions of damper 123.

The tire sensor 52 and the damper sensor 53 are one embodiment of “on-board sensors” of the present invention. Other sensors than the tire sensor 52 and the damper sensor 53, such as a road surface sensor that detects the condition of the road surface or a vibration sensor that detects the vibration of the wheel 11 during driving, may be used as the on-board sensors located on the wheel side. That is, the in-vehicle sensors of the present invention should detect some state quantity of the unsuspended member or the road surface.

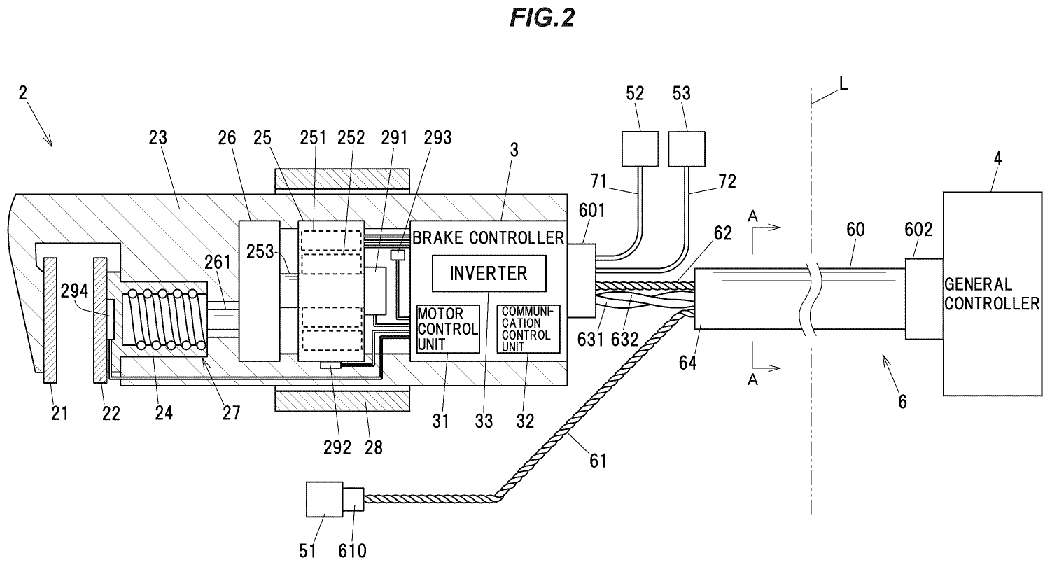

FIG. 2 is an explanatory diagram showing a layout configuration and a wiring structure of the brake controller 3, general controller 4, wheel speed sensor 51, tire sensor 52, damper sensor 53, wiring harness 6, tire sensor-cable 71, and damper sensor-cable 72, along with a schematic example of the electric brake unit 2. In FIG. 2, a boundary line L between the suspended member including the vehicle body 10 and the unsuspended member including the wheel 11 is shown as a two-pointed chain line. The cable 60 has one end disposed on the wheel side above the boundary line L and the other end disposed on the vehicle body side above the boundary line L.

The electric brake unit 2, brake controller 3, wheel speed sensor 51, tire sensor 52, and damper sensor 53 are located on the wheel side and move vertically with the wheels 11 relative to the vehicle body 10 as the suspension springs 124 extend and retract. The general controller 4 is located on the vehicle body side. The brake controller 3 is an embodiment of the “wheel-side controller” of the present invention, and the general controller 4 is an embodiment of the “body-side controller” of the present invention. The cable 60 is wired in the air for a part of its longitudinal direction and connects the brake controller 3 and the general controller 4.

The electric brake unit 2 has an outer brake pad 21 and an inner brake pad 22, a caliper 23 to which the outer brake pad 21 is attached, a piston 24 to which the inner brake pad 22 is attached, an electric motor 25 that drives the electric brake unit 2, a reduction gear 26, which reduces the rotation of the electric motor 25, a rotary to linear motion-conversion mechanism 27 that converts the rotary motion of an output shaft 261 of the reduction gear 26 into the linear motion of the piston 24, and a caliper bracket 28 that is fixed to the mount 133 of the knuckle 13. The caliper 23 is supported by the caliper bracket 28 and can move parallel to the axis of rotation of the wheel 11.

When the electric motor 25 rotates, the outer brake pad 21 and inner brake pad 22 are pressed toward the friction portion 151 of the brake rotor 15 by pressing force corresponding to the torque of the electric motor 25, and the wheel 11 is braked by the friction force generated thereby. The electric motor 25 is a three-phase AC motor and has a cylindrical stator 251 that generates a rotating magnetic field by a three-phase AC current supplied by the brake controller 3, a rotor 252 positioned inside the stator 251, and a motor shaft 253 fixed to the rotor 252. The reduction gear 26 reduces the rotation of the motor shaft 253 to rotate the output shaft 261. The rotary to linear motion-conversion mechanism 27 is composed of, for example, a ball-screw mechanism.

The electric brake unit 2 has multiple motor sensors that detect conditions of the electric motor 25. Specifically, the electric brake unit 2 has, as the motor sensors, a motor rotation angle sensor 291 that detects a motor rotation angle, which is the rotation angle of the rotor 252 relative to the stator 251 of the electric motor 25, a motor temperature sensor 292 that measures the temperature of the electric motor 25, a motor current sensor 293 that measures the current supplied to the stator 251, and a braking force sensor 294 that detects braking force of the electric brake unit 2 by the magnitude of the axial force acting on the piston 24. That is, “motor sensor” is a generic term for the motor rotation angle sensor 291, motor temperature sensor 292, motor current sensor 293, and braking force sensor 294.

The motor rotation angle sensor 291, motor temperature sensor 292, motor current sensor 293, and braking force sensor 294 are connected to the brake controller 3 by wiring in the caliper 23. The brake controller 3 has a motor control unit 31 that controls the electric motor 25, a communication control unit 32 that communicates with the general controller 4, and an inverter 33 that generates the three-phase AC current to supply to the electric motor 25. The brake controller 3 is housed in the caliper 23 of the electric brake unit 2. The brake controller 3 may be located outside the electric brake unit 2. The functions of the motor control unit 31 and the communication control unit 32 are realized by a CPU (arithmetic processing unit) executing a program stored in a semiconductor memory.

The motor control unit 31 calculates the three-phase current values to be supplied to the electric motor 25 based on the detection results of the motor rotation angle sensor 291, motor temperature sensor 292, motor current sensor 293, and braking force sensor 294, and sends PWM (Pulse Width Modulation) signals to the inverter 33 to control the electric motor 25 according to these current values. The inverter 33 has multiple switching elements connected in a three-phase bridge, and the multiple switching elements are turned on or off by the PWM signal. The higher the duty ratio of the PWM signal, the higher the current supplied to the electric motor 25.

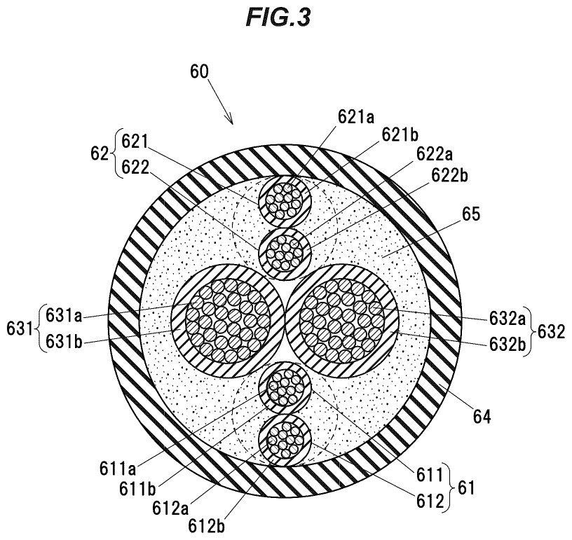

FIG. 3 is a cross-sectional view of the cable 60 taken along the line A-A in FIG. 2. The cable 60 is a composite cable with a wheel speed sensor-signal line 61 to transmit detection signals indicating detection results of the wheel speed sensor 51 to the general controller 4, a shared signal line (common signal line) 62 for communication between the brake controller 3 and the general controller 4, power lines 631, 632 to supply power to the brake controller 3, a hollow tubular sheath 64, and a filler 65. The brake controller 3 and the general controller 4 can communicate bidirectionally via the single shared signal line 62. A binding tape may be wound around the wheel speed sensor-signal line 61, the shared signal line 62, and the power lines 631 and 632. A braided shield or other shield may be placed between the tape and the sheath 64.

The wiring harness 6 comprises the cable 60, a wheel-side connector 601 provided at a wheel-side end of the cable 60, a vehicle body-side connector 602 provided at a vehicle body-side end of the cable 60, and a wheel speed sensor-connector 610. The wheel-side connector 601 is removable from the brake controller 3, and the vehicle body-side connector 602 is removable from the general controller 4. The power lines 631, 632, shared signal line 62, tire sensor-cable 71, and damper sensor-cable 72 are connected to the brake controller 3 through one connector (wheel-side connector 601).

The wheel speed sensor-connector 610 is detachable from the wheel speed sensor 51. The wheel speed sensor-signal line 61, shared signal line 62, and power lines 631, 632 are led out of the sheath 64 adjacent to the knuckle 13. Portions led out of the sheath 64 of the shared signal line 62 and power lines 631, 632 extend toward the brake controller 3, while the wheel speed sensor-signal line 61 is separated from the shared signal line 62 and power lines 631, 632 and extends toward the wheel speed sensor 51. The end of the sheath 64 is secured to the knuckle 13 by a fixture 8, as shown in FIG. 1. The wheel speed sensor-connector 610 may be omitted, and the wheel speed sensor-signal line 61 may be directly connected to the wheel speed sensor 51. That is, the wheel speed sensor-signal line 61 and the wheel speed sensor 51 may be integral, with the wheel speed sensor-signal line 61 leading out from the case of the wheel speed sensor 51.

The wheel speed sensor-signal line 61 is a twisted pair wire comprising a pair of signal wires 611, 612 twisted together. Each of the signal wires 611, 612 is an insulated wire comprising a center conductor 611a, 612a covered with an insulator 611b, 612b made of insulating resin. Similarly, the shared signal line 62 is a twisted pair wire comprising a pair of signal wires 621, 622 twisted together. Each of the signal wires 621, 622 is an insulated wire comprising a center conductor 621a, 622a covered with an insulator 621b, 622b made of insulating resin. The wheel speed sensor-signal line 61 and shared signal line 62 is not limited to the twisted pair wire but may be a coaxial wire, for example.

Each of the power lines 631, 632 is an insulated wire comprising a center conductor 631a, 632a covered with an insulator 631b, 632b made of insulating resin, and supply a DC power voltage of 12 V, for example, to the brake controller 3. The brake controller 3 switches this DC power voltage in the inverter 33. The brake controller 3 transforms this DC power voltage by a DC-DC converter, for example, and uses it as operating power for the CPU and its peripheral circuits.

The sheath 64 is made of resin such as flexible and durable soft polyurethane, for example, and covers the wheel speed sensor-signal line 61, shared signal line 62, and power lines 631, 632 with the filler 65. The filler 65 is a fibrous material such as aramid fiber or nylon fiber, for example.

A command signal indicating the magnitude of the braking force to be generated by the electric brake unit 2 is sent from the general controller 4 to the brake controller 3. The motor control unit 31 of the brake controller 3 controls the electric motor 25 so that the braking force is generated in accordance with this command signal. The communication control unit 32 of the brake controller 3 sends signals indicating detection results of at least the motor temperature sensor 292 and the braking force sensor 294, the tire sensor 52, and the damper sensor 53 among the motor sensors to the general controller 4 via the shared signal line 62. That is, half-duplex communication is performed between the brake controller 3 and the general controller 4 using the single shared signal line 62.

Signals indicating the detection results of each sensor may be transmitted from the brake controller 3 to the general controller 4 via the single shared signal line 62, and a command signal indicating the magnitude of the braking force or the like may be transmitted from the general controller 4 to the brake controller 3 via another signal line. That is, the communication between the brake controller 3 and the general controller 4 may be full-duplex communication.

The detection results of the motor temperature sensor 292, braking force sensor 294, tire sensor 52, and damper sensor 53 are transmitted from the brake controller 3 to the general controller 4 by digital signals. The communication control unit 32 of the brake controller 3 converts detection signals received from each sensor into digital signals and transmits them. The communication control unit 32 may transmit signals indicating the detection results of each sensor to the general controller 4 at the same frequency, or may transmit signals indicating the detection results to the general controller 4 at a higher frequency depending on the speed at which the physical quantity to be detected by each sensor changes, the faster this change is. Specifically, for example, a signal indicating the detection results of the braking force sensor 294 may be transmitted to the general controller 4 at a higher frequency than signals indicating the detection results of the motor temperature sensor 292, tire sensor 52, and damper sensor 53. This allows, for example, an anti-lock control to suppress locking of the wheels 11 when the vehicle 1 is suddenly decelerating or stopping with high accuracy.

### Functions and Effects of Embodiment

According to the present embodiment as described above, since the detection signal of the wheel speed sensor 51 is transmitted to the general controller 4 via a signal line (wheel speed sensor-signal line 61) different from the shared signal line 62, the detection signal of the wheel speed sensor 51 can be continuously transmitted to the general controller 4 at all times, enabling highly precise control of the braking force acting on the wheel 11. Since signals indicating the detection results of the on-board sensors such as the tire sensor 52 and damper sensor 53 can be transmitted to the general controller 4 using the shared signal line 62, the number of signal lines can be reduced compared to the case where the detection signals of these on-board sensors are each transmitted to the general controller 4 using separate signal lines.

Further, according to the present embodiment, even if a failure occurs in the brake controller 3, the detection signal of the wheel speed sensor 51 can be transmitted to the general controller 4 via the wheel speed sensor-signal line 61 so that the general control of the vehicle 1, for example, control of the engine or motor that drives the vehicle 1, control of the steering system, etc. can continue. Even in the event of a failure of the brake controller 3, if the general controller 4 is able to obtain the information on the wheel speeds of the wheels 11, it is possible to stably decelerate or stop the vehicle 1 by appropriately adjusting the braking forces of the other wheels in the vehicle 1.

### Summary of Embodiment

Next, the technical concepts that can be grasped from the embodiment explained above will be described with the aid of the signs, symbols, etc. in the embodiment. Each sign is not limited to the elements in the claims to the members, etc. specifically shown in the embodiment.

According to a first feature, a vehicle wiring structure includes a cable 60, one end of which is located on a wheel side and the other end is located on a vehicle body side. The cable 60 connects a wheel-side controller (brake controller) 3 and a wheel speed sensor 51 located on a wheel side and a vehicle body-side controller (general controller) 4 located on a vehicle body side. The wheel-side controller 3 has a motor control unit 31 that controls the electric motor 25, which drives the electric brake unit 2 that brakes wheels 11, and a communication control unit 32 that communicates with the vehicle body-side controller 4. The communication control unit 32 transmits signals indicating detection results of the motor sensors 291 to 294 that detect conditions of the electric motor 25 and signals indicating detection results of other on-board sensors (tire sensor 52, damper sensor 53) via a single shared signal line 62 to the vehicle body-side controller 4. The cable 60 has the shared signal line 62 and a signal line 61 for the wheel speed sensor 51 that transmits detection signals of the wheel speed sensor 51 to the vehicle body-side controller 4.

According to the second feature, in the vehicle wiring structure as described in the first feature, the on-board sensor is a tire sensor 52 that detects a tire condition.

According to the third feature, in the vehicle wiring structure as described in the first feature, the on-board sensor is a damper sensor 53 that detects a damper condition.

According to the fourth feature, in the vehicle wiring structure as described in the first feature, the motor sensor includes at least one of a braking force sensor 294 that detects braking force of the electric brake unit 2 and a motor temperature sensor 292 that detects temperature of the electric motor 25.

According to the fifth feature, in the vehicle wiring structure as described in any one of the first to fourth features, the cable 60 has a power line 631, 632 that supplies power to the wheel-side controller 3.

According to the sixth feature, in the vehicle wiring structure as described in the fifth feature, the power lines 631, 632, the shared signal line 62, and the wheel speed sensor-signal line 61 are housed in a common sheath 64.

According to the seventh feature, in the vehicle wiring structure as described in the fifth feature, the power lines 631, 632, the shared signal line 62, and the wheel speed sensor-signal line 61 are connected to the wheel-side controller 3 via a single connector (wheel-side connector 601).

According to the eighth feature, a vehicle 1 includes a wheel-side controller 3 located on a wheel side, a vehicle body-side controller 4 located on a vehicle body side, a wheel speed sensor 51 detecting the rotation speed of the wheels, a cable 60 connecting the wheel-side controller 3 and the wheel speed sensor 51 to the vehicle body-side controller 4, and an electric brake unit 2 that brakes wheels 11. The wheel-side controller 3 has a motor control unit 31 that controls the electric motor 25 that drives the electric brake unit 2, and a communication control unit 32 that communicates with the vehicle body-side controller 4. The communication control unit 32 transmits signals indicating detection results of the motor sensors 291, 294 that detect conditions of the electric motor 25 and other on-board sensors 52, 53 to the vehicle body-side controller 4 by a single shared signal line 62. The cable 60 has the shared signal line 62 and a wheel speed sensor-signal line 61 that transmits detection signals of the wheel speed sensor 51 to the vehicle body-side controller 4.

The above embodiment does not limit the invention of the claims. It should be noted that not all of the combinations of features described in the embodiment are essential for the invention to solve the problem.

The present invention can be implemented with variations without departing from the spirit of the invention. For example, the above embodiment describes a case in which the electric brake unit 2 is a disc brake unit that generates braking force on a disc-shaped brake rotor 15, but for example, a drum brake unit that generates braking force on a cylindrical brake drum may also be used.

In the above embodiment, the case in which the communication control unit 32 of the brake controller 3 transmits the signal indicating detection results of the braking force sensor 294 to the general controller 4 via the shared signal line 62 is described, but in view of the fact that the braking force of the electric brake unit 2 is proportional to the magnitude of the current supplied to the electric motor 25, the signal indicating detection results of the motor current sensor 293 may be transmitted to the general controller 4 via the shared signal line 62.

1. A vehicle wiring structure comprising:
a cable having one end located at a wheel side and an other end located at a vehicle body side,
wherein the cable connects a wheel-side controller and a wheel speed sensor located at the wheel side to a vehicle body-side controller located at the vehicle body side,
wherein the wheel-side controller comprises a motor control unit that controls an electric motor that drives an electric brake unit that brakes wheels, and a communication control unit that communicates with the vehicle body-side controller,
wherein the communication control unit transmits signals indicating detection results of a motor sensor that detects motor conditions and signals indicating detection results of an on-board sensor to the vehicle body-side controller via a single shared signal line,
wherein the cable comprises the single shared signal line and a wheel speed sensor-signal line that transmits detection signals of the wheel speed sensor to the vehicle body-side controller.

2. The vehicle wiring structure according to claim 1, wherein the on-board sensor is a tire sensor that detects a tire condition.

3. The vehicle wiring structure according to claim 1, wherein the on-board sensor is a damper sensor that detects a damper condition.

4. The vehicle wiring structure according to claim 1, wherein the motor sensor includes at least one of a braking force sensor that detects braking force of the electric brake unit and a motor temperature sensor that detects temperature of the electric motor.

5. The vehicle wiring structure according to claim 1, wherein the cable includes a power line that supplies power to the wheel-side controller.

6. The vehicle wiring structure according to claim 5, wherein the power line, the single shared signal line, and the wheel speed sensor-signal line are housed in a common sheath.

7. The vehicle wiring structure according to claim 5, wherein the power line, the single shared signal line, and the wheel speed sensor-signal line are connected to the wheel-side controller via a single connector.

8. A vehicle, comprising:
a wheel-side controller located on a wheel side;
a vehicle body-side controller located on a vehicle body side;
a wheel speed sensor that detects a rotation speed of a wheel;
a cable connecting the wheel-side controller and the wheel speed sensor to the vehicle body-side controller; and
an electric brake unit that brakes the wheel,
wherein the wheel-side controller comprises a motor control unit that controls an electric motor that drives an electric brake unit that brakes wheels, and a communication control unit that communicates with the vehicle body-side controller,
wherein the communication control unit transmits signals indicating detection results of a motor sensor that detects motor conditions and signals indicating detection results of an on-board sensor to the vehicle body-side controller via a single shared signal line,
wherein the cable comprises the single shared signal line and a wheel speed sensor-signal line that transmits detection signals of the wheel speed sensor to the vehicle body-side controller.
